(19) United States
(12) Patent Application Publication
(10) Pub. No.: US 2006/0064649 A1
(43) Pub. Date: Mar. 23, 2006

(54) Systems and methods for navigation of a graphical user environment

(75) Inventors: Jason J. Weber, Kirkland, WA (US); Christopher J. McGuire, Monroe, WA (US); Sara S. Ford, Bellevue, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation, Redmond, WA (US)

(21) Appl. No.: 10/948,895

(22) Filed: Sep. 23, 2004

(51) Int. Cl. G06F 17/00

(52) U.S. Cl. 715/811; 715/829

(57) ABSTRACT

Systems and methods are provided for navigating a graphical user interface, or GUI. A list may be invoked by a keyboard shortcut within an integrated development environment, or IDE, for software development wherein there are a number of items such as open files and development tools between which a user must navigate. The list appears in a navigation dialog that comprises the items such as open files, tool windows sorted in a most recently used, or MRU, order, and navigation of abstract views into the data. The list may be invoked by the user from the keyboard by pressing the “Ctrl-Tab” keys, for example, and holding down the “Ctrl” key. Once invoked, the user may navigate the list to select an item to open by using the arrow keys for, example, on the keyboard or pressing the “Tab” key again, for example, while holding down the key used to initially invoke the navigation dialog. Once the user selects the desired item, the navigation dialog may be dismissed by releasing the key used to invoke it.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2004, Microsoft Corp.

### FIELD OF THE INVENTION

This invention relates to computer graphical user interface environments. More particularly, this invention relates to navigation of a graphical user environment having a number of previously opened items.

### BACKGROUND OF THE INVENTION

Many computer users are heavily keyboard-centric users because in a number situations it is often quicker to use the keyboard to input a command or series of commands than using a mouse or other input device. For a graphical user environment (GUI) to accommodate these users, certain keystrokes (or keyboard shortcuts) are often provided as an alternative to entering commands with a mouse. For example, software developers generally rely heavily on such keyboard commands and regularly use these keyboard shortcuts. In an integrated development environment (IDE) such as MICROSOFT VISUAL BASIC 6® or MICROSOFT VISUAL C/C++6® the user would traditionally encounter 10 tool windows and 300 commands. Thus, it was relatively easy for these users to remember the important keyboard shortcuts to successfully use the application. As utilized herein with respect to the invention, a development environment is defined as a software coding environment wherein a developer creates or modifies computer readable instructions according to desired functionality for execution in a computing environment.

The software development industry, however, is currently going through a transition from traditional, focused IDEs to tools platforms. MICROSOFT VISUAL STUDIO®, for example, currently has over 70 tool windows and 3,000 commands, and it is desirable for users to quickly and easily use the keyboard to navigate such tools platforms. Traditional keyboard navigation of these platforms often requires the user to remember a large number of keyboard shortcuts and states of particular tool windows to open a desired item. Users of other software applications having a GUI that involves working with a number of items that the user may need to activate would also benefit from a better way to navigate through such items.

In this regard, there is a need for a system and method that provides a more efficient and natural navigation of a graphical user environment.

### SUMMARY OF THE INVENTION

In consideration of the above-identified shortcomings of the art, the invention provides systems and methods for navigating a graphical user environment. A list may be invoked to appear while in the graphical user environment of a particular software application comprising different types of items that were opened previously with the software application. Also, a list may be invoked to appear comprising previously opened items associated with a development environment for developing software applications.

An item then may be selected from the list and the list is then dismissed automatically once the item is selected. The list may be invoked via a keyboard. One way the list may be invoked via a keyboard is by a user pressing and holding down a first key on a keyboard and then pressing a second key on the keyboard at least once while holding down the first key. The list can then be dismissed simply by releasing the first key. The items in the list may be selected, while holding down the first key, by scrolling through the list by pressing the second key, by pressing the arrow keys on the keyboard in the direction one whishes to scroll, or by pressing any alpha-numeric key to jump directly to that portion of the list. The items in the list may be, for example, files and/or software development tools, or views into abstract containers of information. The list may also be sorted by items most recently used and also such that the list is first sorted by type of item and then by items most recently used. Other advantages and features of the invention are described below.

### BRIEF DESCRIPTION OF THE DRAWINGS

The systems and methods for navigation of a graphical user environment are further described with reference to the accompanying drawings in which:

FIG. 1 is a chart illustrating examples of various windows, each window's state, and associated keyboard shortcuts to open the window within an exemplary graphical user environment;

FIG. 2 is a rendering illustrating an exemplary user interface of a system and method for navigating a graphical user environment;

FIG. 3 is a flow chart illustrating a process for navigating a graphical user environment utilizing a user interface such as the exemplary user interface of FIG. 2;

FIG. 4 is a block diagram showing the architecture of a system for navigating a graphical user environment; and

FIG. 5 is a rendering illustrating the exemplary user interface of FIG. 2 accommodating additional items for the system and methods illustrated in FIGS. 3 and 4 for navigating a graphical user environment.

FIG. 6 is a block diagram representing an exemplary computing device suitable for use in conjunction with various aspects of the invention; and

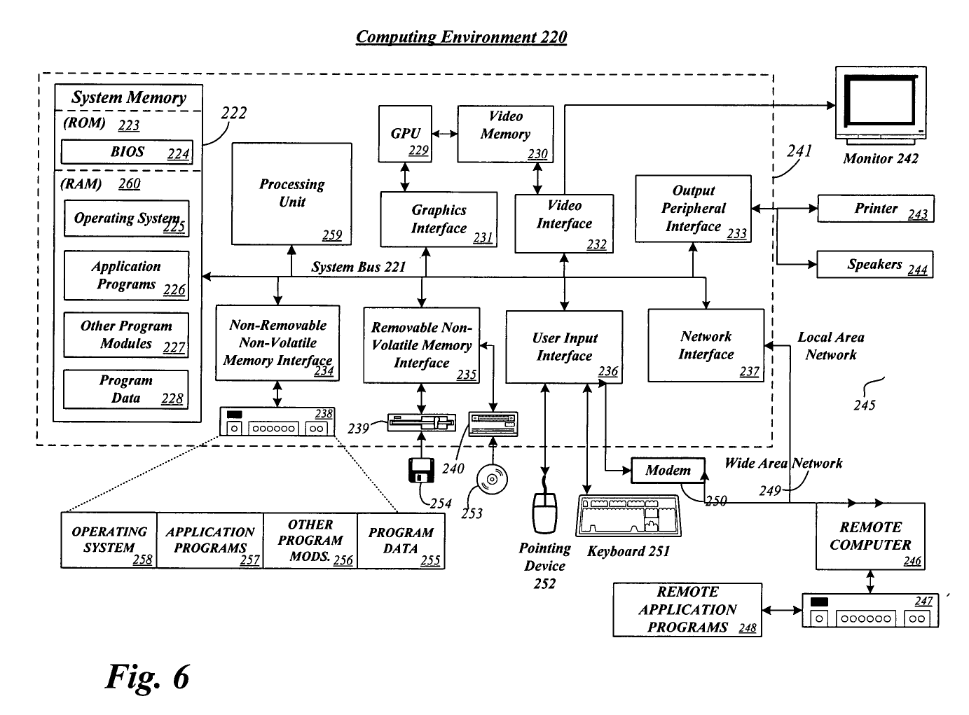

FIG. 7 illustrates an exemplary networked computing environment in which many computerized processes, including those of various aspects of the invention, may be implemented.

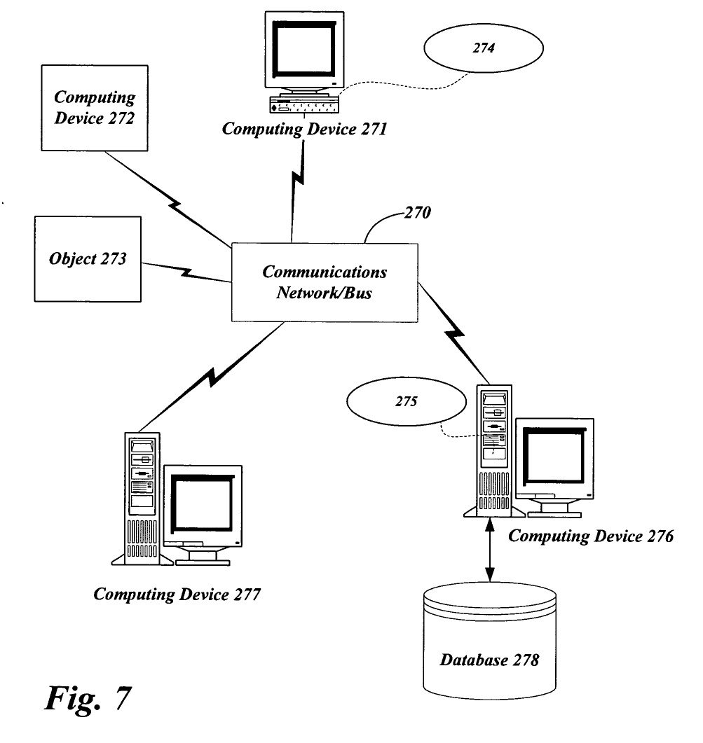

### DETAILED DESCRIPTION OF ILLUSTRATIVE EMBODIMENTS

Certain specific details are set forth in the following description and figures to provide a thorough understanding of various embodiments of the invention. Certain well-known details often associated with computing and software technology are not set forth in the following disclosure to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

Overview

Systems and methods are provided for navigating a GUI. The exemplary GUI is one of an IDE for software development wherein there are a number of items such as open files and development tools between which a user must navigate. A navigation dialog may be invoked by the user from the keyboard wherein the navigation dialog has a list of recently accessed items such as open files and tool windows. Once invoked, the user may navigate the list to select an item to open by using the arrow keys for, example, on the keyboard or pressing the “Tab” key, for example, while holding down the key used to initially invoke the navigation dialog. Once the user selects the desired item, the navigation dialog may be dismissed by releasing the key initially used to invoke it.

First, an exemplary GUI is introduced in the section “Exemplary GUI,” for which the system and method for GUI navigation described herein may be suitable. Second, an exemplary method of navigation is described in the section “GUI Navigation.” Third, a suitable system architecture is described in the section “System Architecture” for the systems and methods of GUI navigation described herein. Finally, a description of a computing and networked environment is provided which will be recognized as generally suitable for use in connection with the systems and methods set forth herein. Because the material in the figures corresponding to the exemplary computing and networked environment is generally for exemplary purposes, the corresponding description is reserved for the end of this specification, in the section entitled “Exemplary Computing and Network Environment.”

Exemplary GUI

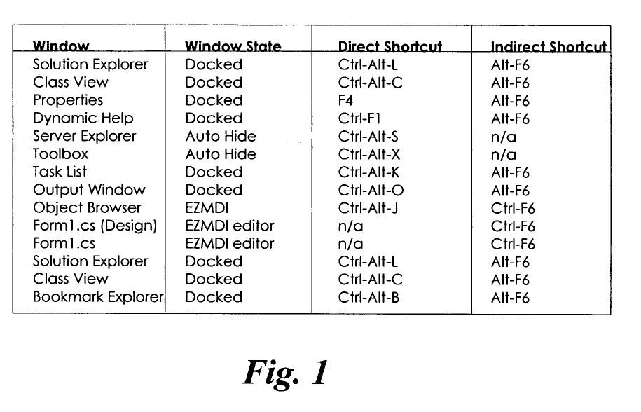

Referring first to FIG. 1, shown is a chart illustrating examples of various windows, each window's state, and associated keyboard shortcuts to open the window within an exemplary graphical user environment. The example in FIG. 1 is corresponds to an IDE for a default MICROSOFT VISUAL STUDIO 7 RTM® installation. Many software application programs, such as the MICROSOFT VISUAL STUDIO 7® IDE for example, have the ability to show windows giving views of more than one document at a time. This is known as a multiple document interface, or MDI. In the present example, there are 44 tool windows wherein each tool window may be in one of the following five states:
1. Docked (a tool window that is attached to a side of the IDE and visible).
2. Floating (a tool window that is floating over the IDE).
3. Auto Hide (a docked tool window that is hidden against the side of the IDE).
4. MDI tool (a tool window that is in the document windows bay).
5. MDI editor (an editor window that is in the document windows bay).

Before a user can navigate around the IDE with a keyboard, the user must know the state of a tool window. In doing so, the user must locate that tool window on the screen. For example, in MICROSOFT VISUAL STUDIO 7®, if the object browser tool window is docked in the MDI space, called the EZMDI® space, the user will likely press Ctrl-F6 on the keyboard to indirectly walk the EZMDI® documents. If the object browser is a visible docked tool window, the user may press Alt-F6, for example, to indirectly walk the tool windows. If the object browser is an auto hide tool window the user may press Ctrl-Alt-J on the keyboard to directly jump to that control.

In a clean MICROSOFT VISUAL STUDIO 7® installation with a new C# project open, for example, a user must know 11 keyboard shortcuts to efficiently navigate the IDE without using a mouse. This number grows significantly when the remaining 35 tool windows are factored in and when the user changes the state of tool windows. For example, in a worst case scenario a user could be forced to know 31 different keyboard shortcuts to navigate the IDE.

In addition to the sheer number of keyboard shortcuts discussed above, moving between open files with the keyboard provides additional challenges. A user may press Ctrl-F6 and Ctrl-Shift-F6, for example, to indirectly walk the open files. However, when more than 10 files are open it is often inconvenient.

Discussed below is a more intuitive way for users to navigate a GUI, such as an IDE, from the keyboard. More efficient and natural navigation of a GUI is provided by eliminating the user having to first think about things such as state information, about whether the user is jumping to a file or a tool window, and about whether a direct or indirect keyboard shortcut is needed to open an item.

GUI Navigation

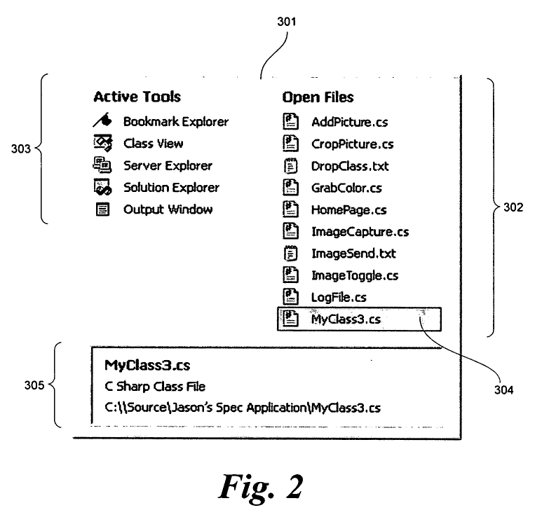

Referring to FIG. 2, shown is a rendering illustrating an exemplary user interface of a system and method for navigating a graphical user environment. This interface 301, hereafter referred to as the navigator dialog 301, is an exemplary interface showing as an example particular files 302 and active tools 303 that may be associated with MICROSOFT VISUAL STUDIO®. Although the navigator dialog and associated system for navigating a graphical user environment may be particularly suited for the MICROSOFT VISUAL STUDIO® IDE, the navigator dialog 301 is not limited to any particular IDE or software application as the files and other objects that may appear in and be accessed through the navigator dialog may be various objects and files from any number of different applications. However, any application or development tool in which the user works with a large number of different files or objects in a given session is particularly suited for the system and methods set forth herein.

Once invoked by the user, the navigator dialog 301 appears. The navigator dialog 301 comprises a list of items such as open files 302 and active tools 303, a cursor 304 indicating to the user which item is currently selected, and an object information area 305 containing information about the currently selected item in the navigator dialog 301. The list of open files and active tools is sorted according to the file or tool window most recently used (MRU) by the user. Files, as used herein, means any set of stored bits that can be referenced for retrieval by a file system of a computer, and includes, but is not limited to, object files, dynamic link libraries, source code files, content such as image files, sound files, movie files, etc. In the example provided in FIG. 2, the most recently used file is “AddPicture.cs” and the least recently used file is “MyClass3.cs.” Likewise, the most recently used active tool is “Bookmark Explorer” and the least recently used active tool is “Output Window.” In the instance illustrated, the exemplary file “MyClass3.cs” is currently selected and the information displayed is file name (“MyClass3.cs”), type of file (“Sharp Class File”) and file location such as the relative path (“C:\\Source\Jason's Spec Application\MyClass3.cs”). However, more or less information about the item may also be displayed as is desirable for the particular application. As described in detail below, the user will be able to easily navigate between different active tools and different open files using the keyboard.

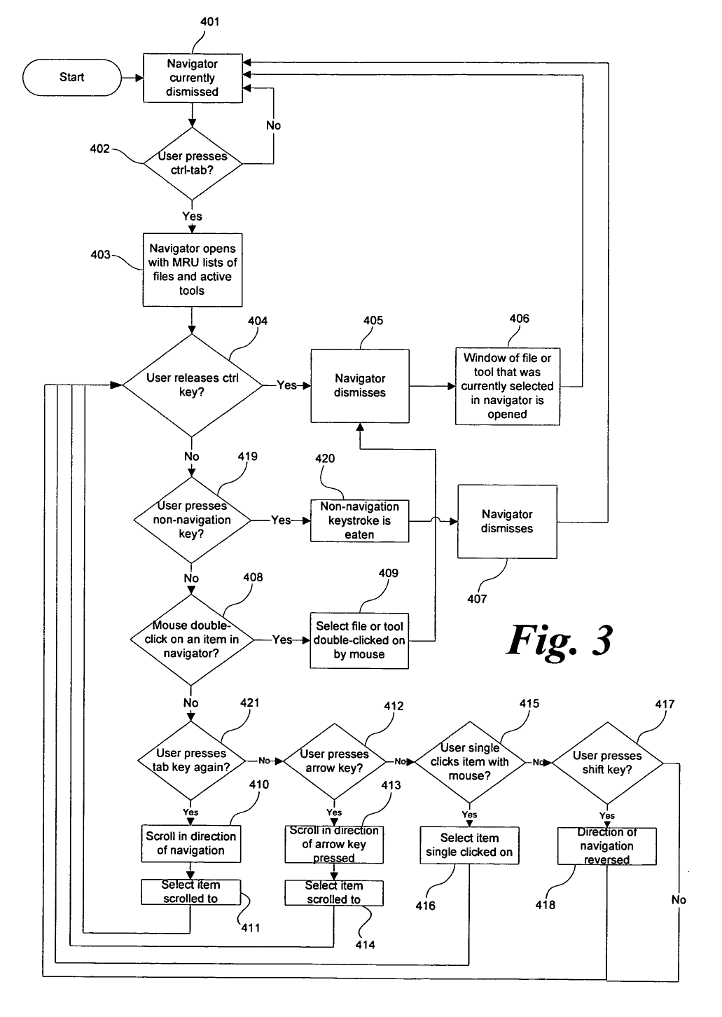

Referring additionally to FIG. 3, shown is a flow chart illustrating a process for navigating a graphical user environment utilizing a user interface such as the exemplary user interface of FIG. 2. In a user's application, the navigator dialog 301 is initially in a dismissed state 401. The user invokes the navigator dialog by holding down the standard keyboard key “Ctrl” and then pressing the “Tab” key concurrently 402. Other keystrokes may also be used and be programmed by the user, however, the “Ctrl” and “Tab” keys are particularly suited for the present application due to the location of the keys on the keyboard, the traditional use of these keys, as well as for other reasons which will become evident from the way in which the items are selected in the navigator dialog 301.

Once invoked, the navigator dialog 301 opens 403 with a list of open files 302 and active tools 303 sorted in an MRU order as described above. The most recently used file is selected by default when the navigator dialog 301 is invoked. For example, the position of the cursor 304 is at the most recently used file initially when the navigator dialog 301 opens. However, if the user is already working in a file when the navigator dialog 301 is invoked, then the next most recently used file is initially selected. Alternatively, the most recently used active tool may be selected by default when the navigator dialog is invoked. This may be implemented instead of, or as an additional command to invoking the navigator dialog with the most recently used file being selected initially. In the case of it being an additional command, the user would invoke it by holding down the standard keyboard key “Alt” and then pressing the “F7” key concurrently. This will allow users to quickly jump between a file and tool window.

The navigator dialog will remain open as long as the “Ctrl” key is being pressed by the user. However, if the user releases the “Ctrl” key 404, then the navigator dialog dismisses 405 and the currently selected item (i.e., the item at which the cursor 304 is currently positioned) is activated by opening the window of that item 406, for example. The navigator dialog 301 may then be invoked again by pressing the “Ctrl” and “Tab” keys.

If the user continues to hold down the “Ctrl” key but at any time presses a key on the keyboard that does not otherwise affect navigation 419 in the navigator dialog 301, then that keystroke is eaten 420 without being passed to the application such as the IDE. The navigator dialog 301 then dismisses 407 without taking any action. For example, if the user is working in the editor of the IDE and invokes the navigator dialog and the user then presses the “Backspace” key, the Navigator dialog will dismiss 407 and the backspace will not occur in the editor of the IDE. This prevents keys accidentally pressed by the user from making unintended changes in other areas of the IDE.

Continuing to hold down the “Ctrl” key, if the user at any time double-clicks on an item in the navigator dialog 301 with a mouse, then that item is selected 409, the navigator dialog 301 is dismissed 405 and that item is activated 406 (say by opening the window of the file selected, for example). Also, if at any time while holding down the “Ctrl” key, the user presses the “Tab” key again 421 after initially invoking the navigator dialog 301, the cursor scrolls to 410 and selects 411 (by highlighting, for example) the next item in the current direction of navigation, which is either up or down the current list in the navigator dialog 301At that point, if the user releases the “Ctrl” key 404 the navigator dialog 301 is dismissed 405 and the item currently selected is activated 406 (such as by opening the widow of that item, for example). Also, if at any time the user presses any of the arrow keys 412 while holding down the “Ctrl’ key, the cursor 304 then scrolls 413 in the direction of the arrow key pressed. This may be up, down, left or right and enables the user to easily go between items within a list or between lists, such as between the list of open files and active tools in the navigator dialog 301. The cursor 304 selects 414 the item at which the cursor stops when the arrow key is released. Again, at that point the user may release the “Ctrl” key 404 to dismiss 405 the navigator dialog 301 and activate the item currently selected 406.

If the user chooses to use a mouse to select an item, at any time while holding down the “Ctrl” key the user may single-click 415 on an item in the navigator dialog 301 with the mouse and it will be selected 416 by having the cursor move to the position of that item. Then, by releasing the “Ctrl” key, the navigator dialog 301 will be dismissed 405 and that item will be activated 406. Also, the user may change the current direction of navigation for use in navigation with the “Tab” key as described above by at any time pressing the “Shift” key 417 while continuing to hold down the “Ctrl” key. The direction of navigation is then changed 418 such that when the user presses the “Tab” key again 409 while continuing to hold down the “Ctrl” key, the cursor 304 will scroll 410 in the opposite direction as it would have before pressing the “Shift” key.

System Architecture

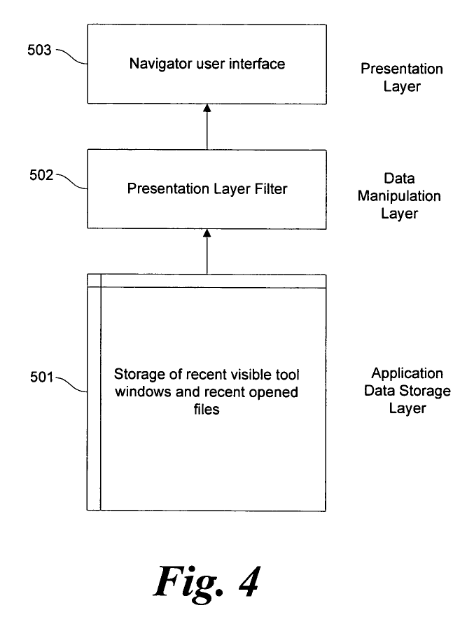

Referring next to FIG. 4, shown is a block diagram illustrating an exemplary architecture of a system for navigating a graphical user environment. Shown is storage of recently accessed items 501, such as recently visible tool windows and recently opened files at a conceptual application data storage layer. Also illustrated is a presentation layer filter 502 at data manipulation layer and the navigator user interface (the navigator dialog, for example) at a presentation layer. Stored at the application data storage layer is a constantly maintained list of recently accessed items such as recently used visible tool windows and recently opened files. This list may be as large as the storage space allocated in the particular application allows and, for example, may often include as many as 500 visible tool windows.

At the presentation layer filter 502, the recently accessed items of particular interest from all the stored recently accessed items is selected. For example, this may be the 15 most recently used visible tool windows from a stored group of 500 most recently used visible tool windows as it may not be practicable to display all of the recently accessed items stored. This group of recently accessed items of particular interest is then passed to the presentation layer for display in the navigator user interface 503 (i.e., the navigator dialog).

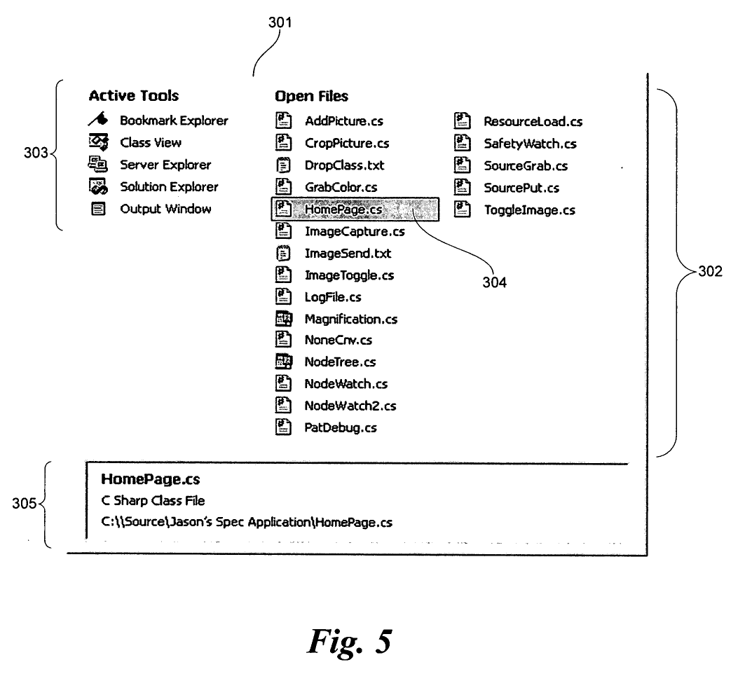

Referring next to FIG. 5, shown is a rendering illustrating the exemplary user interface of FIG. 2 accommodating additional items for the system and methods illustrated in FIGS. 4 and 5 for navigating a graphical user environment. The navigator dialog 301 will dynamically resize in both height and width to accommodate more items. The navigator dialog 301 has the ability to scale and display up to 15 active tools and 60 open files, for example. This is five columns of 15 items each. However, although it is rare for a user to have more than 11 active tools or more than 30 open files, the navigator dialog accommodates a larger numbers of items by allowing the user to scroll within the navigator dialog to display more items.

Exemplary Computing and Network Environment

Referring to FIG. 9a, shown is a block diagram representing an exemplary computing device suitable for use in conjunction with various aspects of the invention. For example, the computer executable instructions that carry out the processes and methods navigating a graphical user environment as described above may reside and/or be executed in such a computing environment as shown in FIG. 9a. The computing system environment 220 is only one example of a suitable computing environment and is not intended to suggest any limitation as to the scope of use or functionality of the invention. Neither should the computing environment 220 be interpreted as having any dependency or requirement relating to any one or combination of components illustrated in the exemplary operating environment 220.

Aspects of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the invention may be implemented in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An exemplary system for implementing aspects of the invention includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 9a illustrates operating system 225, application programs 226, other program modules 227, and program data 228.

The computer 241 may also include other removable/non-removable, volatile/nonvolatile computer storage media. By way of example only, FIG. 9a illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 9a, provide storage of computer readable instructions, data structures, program modules and other data for the computer 241. In FIG. 9a, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 9a. The logical connections depicted in FIG. 9a include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 9a illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments refer to utilizing aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

An exemplary networked computing environment is provided in FIG. 9b. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 9b provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 9b, and may itself represent multiple interconnected networks. In accordance with an aspect of the invention, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 9b, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 9a and the further diversification that can occur in computing in a network environment such as that of FIG. 9b, the systems and methods provided herein cannot be construed as limited in any way to a particular computing architecture. Instead, the invention should not be limited to any single embodiment, but rather should be construed in breadth and scope in accordance with the appended claims.

What is claimed:

1. A method for navigating a graphical user interface comprising invoking a list comprising previously accessed items associated with a development environment for developing software applications.

2. The method of claim 1, further comprising selecting an item from the list.

3. The method of claim 2 further comprising dismissing the list automatically once the item is selected.

4. The method of claim 2 wherein the list is invoked via a keyboard.

5. The method of claim 3 wherein the dismissing step comprises releasing a key on a keyboard.

6. The method of claim 2 wherein the invoking step comprises:
pressing and holding down a first key on a keyboard; and
pressing a second key on the keyboard at least once while holding down the first key.

7. The method of claim 6, further comprising dismissing the list by releasing the first key.

8. The method of claim 6 wherein the selecting step comprises pressing the second key again to scroll through the list until a desired item is reached.

9. The method of claim 6 wherein the selecting step comprises using one or more keys of a keyboard to select a desired item.

10. The method of claim 1 wherein the list of items comprises files.

11. The method of claim 10 wherein the list of items further comprises software development tools.

12. The method of claim 2 wherein the development environment for developing software applications is an integrated development environment comprising at least a source code editor and a compiler.

13. The method of claim 2 wherein the list is sorted by items most recently used.

14. The method of claim 2 wherein the list is first sorted by type of item and then by items most recently used.

15. A method for navigating a graphical user interface comprising:
pressing and holding down a first key on a keyboard while in a graphical user environment of a particular software application; and
pressing a second key on the keyboard at least once while holding down the first key, thereby invoking a list to appear within the software application comprising different types of items that were opened previously with the software application.

16. The method of claim 15, further comprising selecting an item from the list.

17. The method of claim 16 further comprising dismissing the list automatically once the item is selected.

18. The method of claim 17 wherein the dismissing step comprises releasing the first key.

19. The method of claim 16 wherein the selecting step comprises pressing the second key again to scroll through the list until a desired item is reached.

20. The method of claim 16 wherein the selecting step comprises using one or more keys of a keyboard to select a desired item in the list.

21. The method of claim 15 wherein the list is sorted by items most recently used.

22. The method of claim 15 wherein the list is first sorted by type of item and then by items most recently used.

23. A computer readable medium having stored thereon a plurality of computer-executable instructions for navigating a graphical user interface, said computer-executable instructions performing the method of invoking a list to appear comprising previously opened items associated with a development environment for developing software applications.

24. The computer readable medium of claim 23, further having stored thereon a plurality of computer-executable instructions for selecting an item from the list.

25. The computer readable medium of claim 24, further having stored thereon a plurality of computer-executable instructions for dismissing the list automatically once the item is selected.

26. The computer readable medium of claim 25 wherein the computer-executable instructions for dismissing comprise computer-executable instructions for dismissing the list upon releasing a key on a keyboard.

27. The computer readable medium of claim 24 wherein the computer-executable instructions for invoking comprise computer-executable instructions for invoking the list via a keyboard.

28. The computer readable medium of claim 24 wherein the computer-executable instructions for performing the invoking step comprises computer-executable instructions for invoking the list when a user performs the method of:
pressing and holding down a first key on a keyboard; and
pressing a second key on the keyboard at least once while holding down the first key.

29. The computer readable medium of claim 28, further having stored thereon a plurality of computer-executable instructions for dismissing the list upon the user releasing the first key.

30. The computer readable medium of claim 24 wherein the list is sorted by items most recently used.

31. The computer readable medium of claim 24 wherein the list is first sorted by type of item and then by items most recently used.

32. A computer readable medium having stored thereon a plurality of computer-executable instructions for navigating a graphical user interface, said computer-executable instructions for performing a method comprising:
first determining that a user of a software application having a user interface pressed and held down a first key on a keyboard;
second determining that the user pressed a second key on the keyboard at least once while holding down the first key; and
invoking a list within the software application in response to said second determining, said list comprising different types of items that were opened previously with the software application.

33. The computer readable medium of claim 32, further having stored thereon a plurality of computer-executable instructions for selecting an item from the list.

34. The computer readable medium of claim 33, further having stored thereon a plurality of computer-executable instructions for dismissing the list automatically once the item is selected.

35. A user interface component for navigating a graphical user interface, comprising:
a list component for instantiating the display of a list comprising elements that refer to previously opened items associated with a development environment for developing software.

36. The user interface component of claim 35, further comprising:
an input component for receiving a selection of an item from the list.

37. The user interface component of claim 36, wherein said list component dismisses the list once the item is selected via the input component.

38. The user interface component of claim 37, wherein the item is selected by releasing a key on a keyboard.

39. The user interface component of claim 36, wherein the list component instantiates the display of the list when the input component receives a selection via at least one keyboard input of a keyboard.

40. The user interface component of claim 39, wherein the list component instantiates the display of the list when the input component receives a selection via at least one keyboard input, wherein said at least one keyboard input includes:
first input relating to pressing and holding down a first key on the keyboard; and
second input relating to pressing a second key on the keyboard at least once while holding down the first key.

41. The user interface component of claim 40, wherein the list component destructs the list the first key of the keyboard is released.

42. The user interface component of claim 40, wherein the list component scrolls a current item in the list to be selected to a next item in the list in response to receiving input relating to pressing the second key again.

43. The user interface component of claim 40, wherein the list component moves a current item in the list to be selected to a next item in response to receiving input relating to at least one key of the keyboard.

44. The user interface component of claim 35, wherein the list of items comprises files.

45. The user interface component of claim 44, wherein the list of items further comprises software development tools.

46. The user interface component of claim 35, wherein the development environment for developing software applications is an integrated development environment comprising at least a source code editor and a compiler.

47. The user interface component of claim 35, wherein the list is sorted by items most recently used.

48. The user interface component of claim 35, wherein the list is first sorted by type of item and then by items most recently used.

49. A computer readable medium comprising computer executable modules having computer executable instructions for navigating a graphical user interface, the modules comprising:
means for invoking a list comprising previously opened items associated with a development environment for developing software applications.

50. A computer readable medium according to claim 49, wherein said means for invoking a list includes:
means for determining that a first key has been pressed and held down on a keyboard and that a second key on the keyboard has been pressed at least once while the first key continues to be held down; and
means for instantiating a list within the software application in response to said means for determining, said list comprising different types of items that were opened previously with the software application.
